(19) United States
(12) Patent Application Publication
(10) Pub. No.: US 2011/0019404 A1
(43) Pub. Date: Jan. 27, 2011

(54) REFLECTIVE HOUSING AND LED ILLUMINATOR USING SAME

(75) Inventors: MING-CHIN CHIEN, Chu-Nan (TW); AN-CHI WEI, Chu-Nan (TW); JYH-LONG CHERN, Chu-Nan (TW); WEN-JANG JIANG, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/683,566

(22) Filed: Jan. 7, 2010

(30) Foreign Application Priority Data
Jul. 23, 2009 (CN) 200910304706.6

(51) Int. Cl. F21V 1/00; F21V 7/00

(52) U.S. Cl. 362/235; 362/341

(57) ABSTRACT

An exemplary reflective housing for a LED illuminator is provided. The reflective housing includes a plurality of side walls cooperatively forming a hollow shell. The hollow shell has a first opening and a second opening opposite to the first opening. The hollow shell tapers from the first opening to the second opening. Inner surfaces of the side walls are light reflective surfaces. The first opening has a polygonal shape having more than four sides. The first opening includes two parallel sides. Four endpoints of the first opening cooperatively form an imaginary quadrangle. Remaining sides are located at an exterior of the imaginary quadrangle. A line segment obtained by intersecting any straight lines parallel to the parallel sides is shorter than a distance between the two parallel sides. The second opening is configured for accommodating an LED light source therein.

### BACKGROUND

1. Field of the Invention

The present disclosure relates generally to an illuminator, and particularly to a reflective housing and an illuminator having the reflective housing, and a light source.

2. Description of Related Art

In recent years, light emitting diodes (LEDs) have become highly efficient light sources and are used widely in such fields as automotive, displays, and street illuminators.

Light generated by LEDs has the advantage in that it can be redirected or aimed by using some kind of reflectors. However, because a light field of the LED is usually concentrated, illuminating devices using LEDs cannot meet the needs of illuminating a relatively large area. Further, in some cases, such as the street lamp, a long and narrow light field is desired but not easily obtained with present methods.

Therefore, there is a need in the art for a reflective housing and an LED illuminator, which overcomes the above-mentioned shortcomings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an isometric view of an LED illuminator in accordance with a first embodiment.

FIG. 2 is an exploded, isometric view of the LED illuminator of FIG. 1.

FIG. 3 is a cross-sectional view taken along line III-III of FIG. 1.

FIG. 4 shows a light field of the LED illuminator of FIG. 1.

FIG. 5 is a diagram showing a light-distributing curve for illumination of the LED illuminator of FIG. 1.

FIG. 6 is a cross-sectional view of a reflective housing for an LED illuminator in accordance with a second exemplary embodiment.

FIG. 7 is a cross-sectional view of a reflective housing for an LED illuminator in accordance with a third exemplary embodiment.

FIG. 8 is a cross-sectional view of a light-pervious cover of an LED illuminator in accordance with a fourth exemplary embodiment.

FIG. 9 is a cross-sectional view of a light-pervious cover of an LED illuminator in accordance with a fifth exemplary embodiment.

FIG. 10 is a cross-sectional view of a light-pervious cover of an LED illuminator in accordance with a sixth exemplary embodiment.

FIG. 11 is a top plan view of an LED illuminator in accordance with a seventh embodiment.

FIG. 12 is a diagram showing a light-distributing curve for illumination of the LED illuminator of FIG. 11.

### DETAILED DESCRIPTION

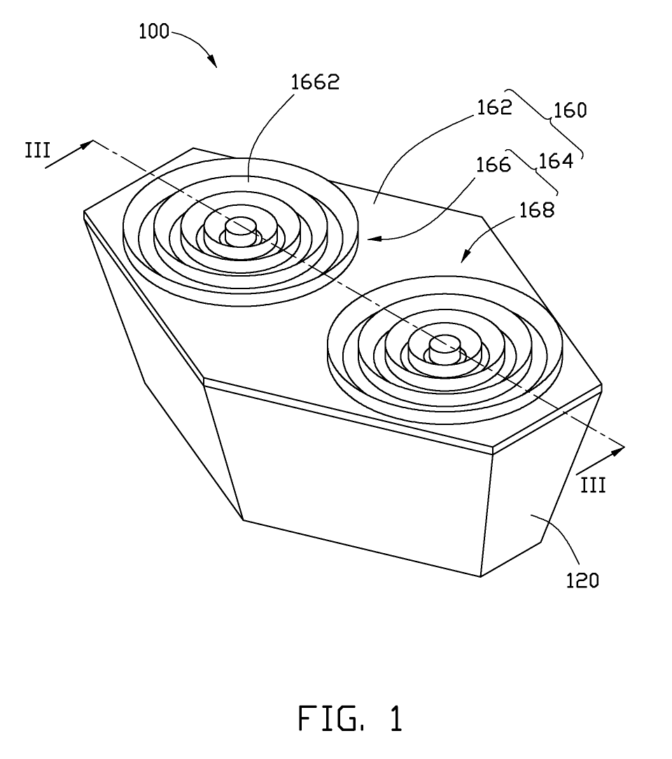

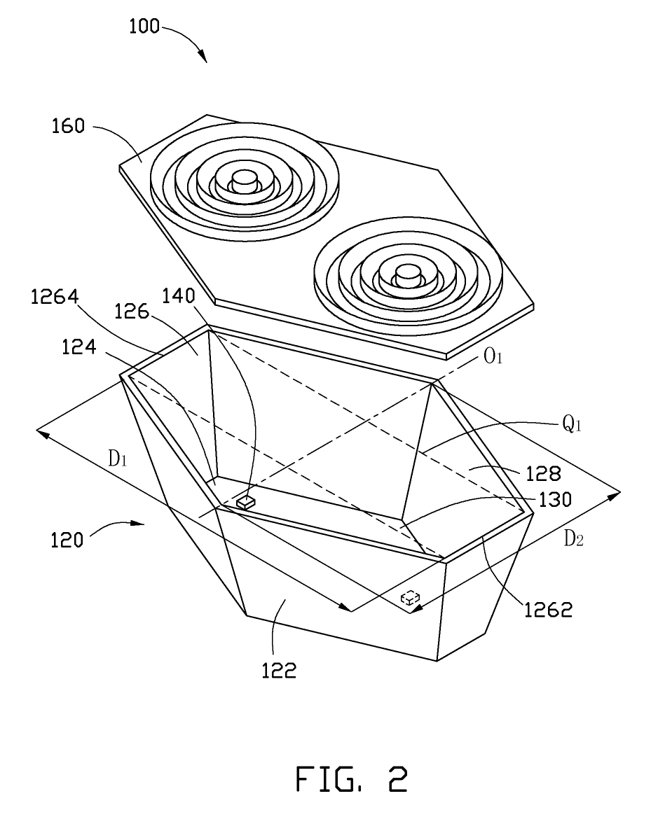

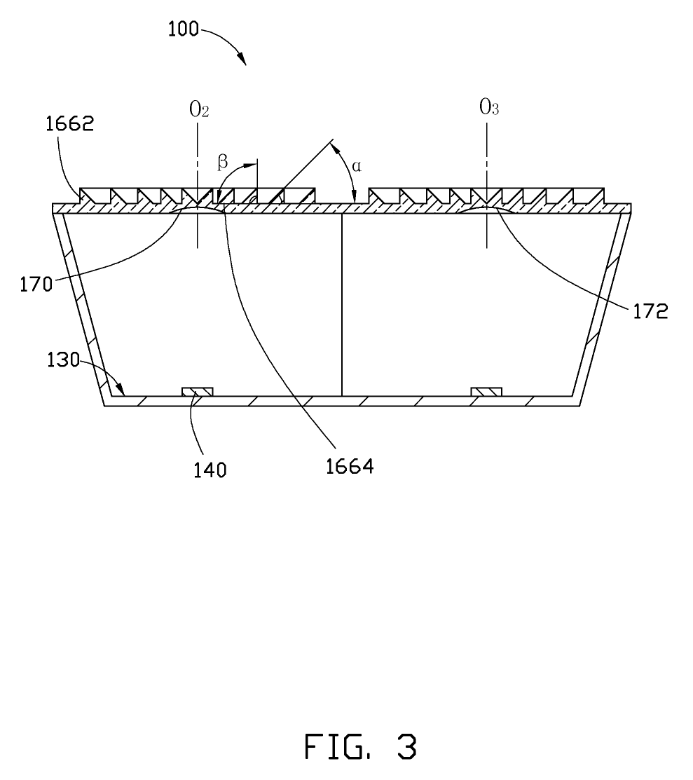

Referring to FIGS. 1 to 3, an LED illuminator 100 of a first exemplary embodiment includes a reflective housing 120, two light sources 140 and a light-pervious cover 160.

The reflective housing 120 has a hollow frustum shape of hexagonal-pyramid. The reflective housing 120 includes six side walls 122 and a bottom wall 124. The bottom wall 124 is fixed to one distal end of each side wall 122. A hexagonal opening 126 is defined opposite to the bottom wall 124. The reflective housing 120 tapers from the hexagonal opening 126 to the bottom wall 124. An inner surface of each of the side walls 122 is a reflective surface 128. In this embodiment, the reflective surface 128 is a flat surface. An inner surface of the bottom wall 124 is a fixing surface 130 for fixing the two light sources 140 thereon. Light emitted from the light sources 140 are transmitted to exterior through the hexagonal opening 126.

The fixing surface 130 has a substantially same shape as the hexagonal opening 126. Therefore, only the opening 126 is described in detail as follows. The hexagonal opening 126 is axially symmetric in respect to an axial line O1 that passes through two endpoints of the hexagonal opening 126. The hexagonal opening 126 has two sides 1262 and 1264 parallel with the axial line O1. The two parallel sides 1262 and 1264 are at two opposite sides of the axial line O1 and have a distance D1 therebetween. Straight lines parallel with the parallel sides 1262 and 1264 are intersected by the sides of the hexagonal opening 126 to form line segments. The longest one of the line segments has a distance D2 between two endpoints of the opening 126 that the axial line O1 passes through. The distance D1 is larger than the distance D2. Four endpoints of the two sides 1262 and 1264 cooperatively form an imaginary quadrangle Q1. The remaining two endpoints of the hexagonal opening 126 passing through the axial line O1 are located at an exterior of the imaginary quadrangle Q1, thereby forming two structures projected from the imaginary quadrangle Q1.

The two light sources 140 are fixed on the fixing surface 130. Because the fixing surface 130 has a substantially same shape as the hexagonal opening 126, the fixing surface 130 has an axial (not labeled) corresponding to the axial line O1 and two sides (not labeled) parallel with the axial of the fixing surface 130. The two light sources 140 are located at two opposite sides of the axial and adjacent to the two parallel sides of the fixing surface 130, respectively. In this embodiment, each of the light sources 140 is an LED. Alternatively, each of the light sources 140 can also be an LED array containing a number of LEDs. The two light sources 140 are configured for emitting visible light to exterior through the opening 126.

The light-pervious cover 160 includes a light-pervious base panel 162 and light-pervious, optical micro-structures 164 formed on the base panel 162. In an alternative embodiment, the base panel 162 has a same material as and is integrally formed with the micro-structures 164. That is, the light-pervious cover 162 is a single body of material comprising the base panel 162 and the micro-structures 164. The micro-structures 164 include two concentric ring-shaped prism groups 166 and 168. In this embodiment, the two prism groups 166 and 168 are identical with each other. Here only the prism group 166 is described in detail as follows.

The prism group 166 includes a number of concentric ring-shaped prisms 1662, with a common central axis O2. In this embodiment, the number of the concentric ring-shaped prism 1662 is five. Each of the ring-shaped prisms 1662 has a triangular cross section. The triangle of the ring-shaped prism 1662 has a base 1664 located on the light-pervious plate 162. The base 1664 has a length in a millimeter level. Preferably, the length of the base 1664 is in the range from 1 millimeter to 1 centimeter. The triangle of each ring-shaped prism 1662 defines two base angles α and β adjacent to the base 1664, wherein the base angle α is adjacent to the central axis O2. In this exemplary embodiment, the base angle α is smaller than the base angle β, thereby the light transmitted through the ring-shaped prism 1662 can be diffused efficiently. Spaces between two adjacent ring-shaped prisms 1662 gradually increase along a radial direction from the central axis O2 to a periphery of the ring-shaped prisms 1662, thus causing uniform distribution of the light transmitted through the light-pervious cover 160. In a preferred embodiment, each of the distances between adjacent ring-shaped prisms 1662 is in the range from 1 millimeter to 1 centimeter. Corresponding to the concentric ring-shaped prism group 166, the concentric ring-shaped prism group 168 has a central axis O3.

The wall of the reflective housing 120 at the opening 126 and the light-pervious cover 160 abut each other, with the interface sealed therebetween. The sealing may be achieved by, e.g., interference fit or applied transparent adhesive. Thereby, the light-pervious cover 160 is fixed to the wall of the reflective housing 120. In the illustrated embodiment, the central axis O2 of the prism group 166 and the central axis O3 of the prism group 168 pass through the two light sources 140, respectively. Therefore, the concentric ring-shaped prism groups 166 and 168 can diffuse the light emitted from the light sources 140 efficiently.

The light-pervious plate 162 defines two curved recesses 170 and 172 in one surface of the light-pervious plate 162 facing toward the fixing surface 130. The curved recesses 170 and 172 are aligned with the two light sources 140, respectively. Each of the curved recesses 170 and 172 can be selected from the group consisting of a spherical surface, a cylindrical surface and an aspherical surface. The curved recesses 170 and 172 are configured for diffusing light.

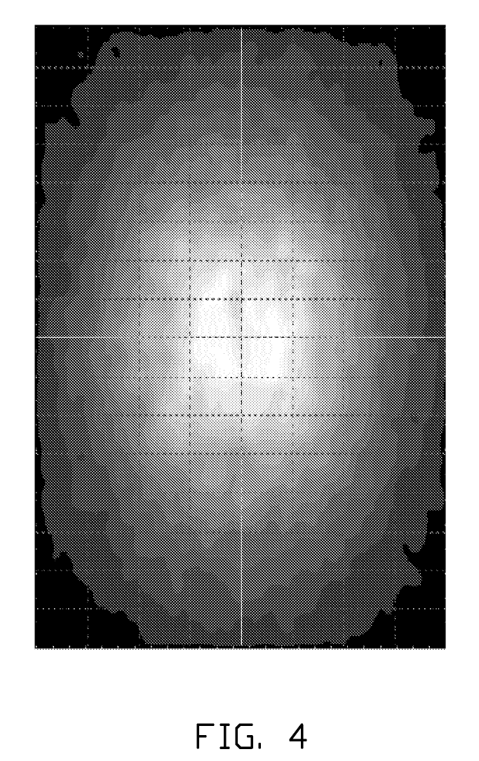

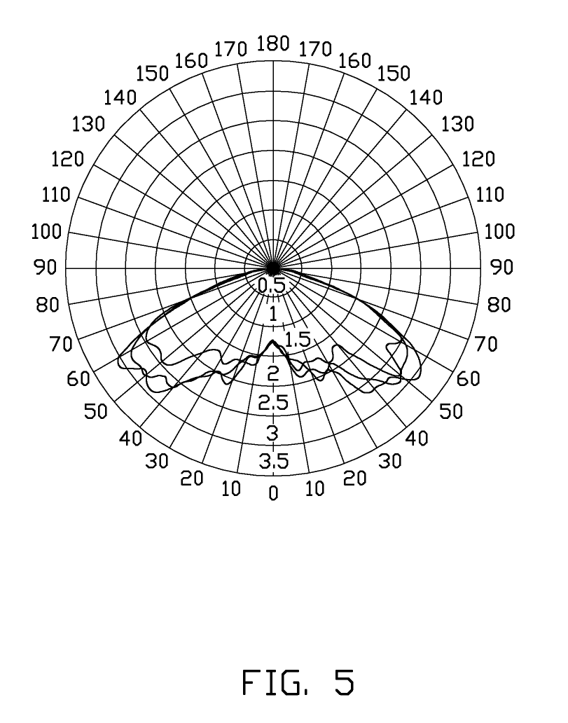

Referring to FIG. 4, a light field of the LED illuminator 100 is shown. Because the distance D1 between the two parallel sides 1262 and 1264 is larger than the distance D2 between endpoints that the axial line O1 passes through, the light field of the LED illuminator 100 has an approximate elongated shape. This light field is advantageous when the LED illuminator 100 is for a street lamp, because more light will be utilized to illuminate the street when the axial line O1 is perpendicular to a direction which the street extends. Additionally, there is a structure projected from the imaginary quadrangle Q1, therefore, more light will be reflected to the opening 126 than by using an illuminator with a quadrangle opening, thereby forming a larger light field. Further more, with diffusion of micro-structures 164 and the curved recesses 170 and 172, the brightness in the light field distributes uniformly. Referring to FIG. 5, a light-distributing curve for illumination of the LED illuminator 100 shows a shape of full width at half maximum.

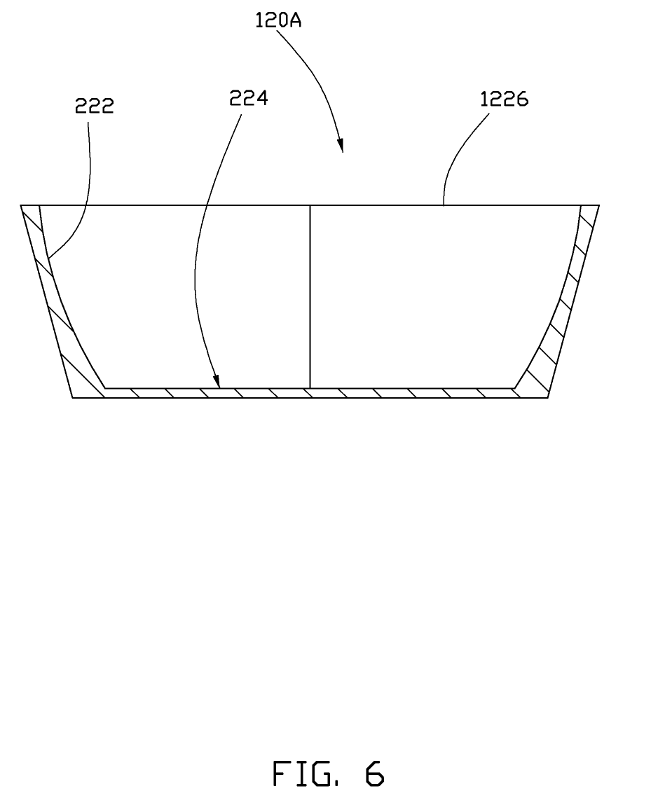

Referring to FIG. 6, this shows a reflective housing 120A of a second embodiment. The reflective housing 120A is differs from the reflective housing 120 in that a reflective surface 222 interconnecting an opening 226 and an fixing surface 224 has a concave cylindrical shape.

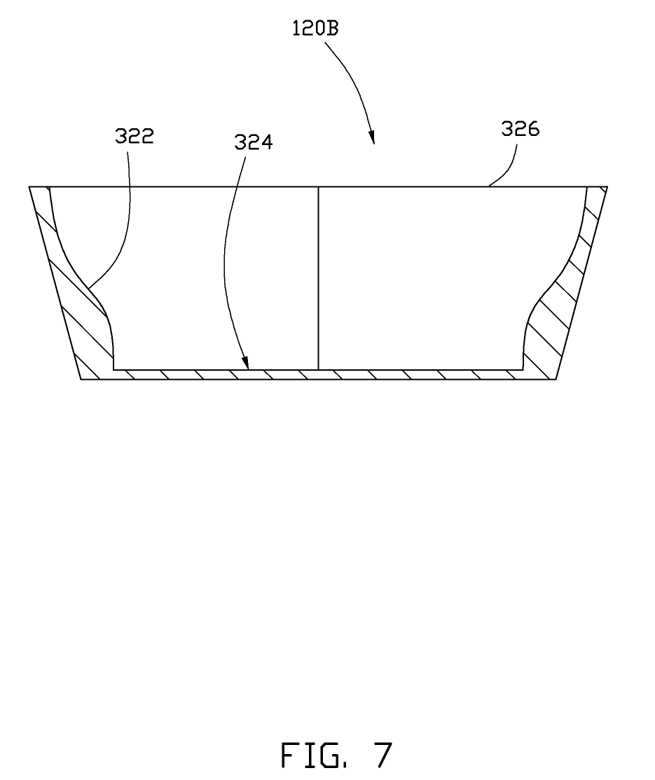

Referring to FIG. 7, this shows a reflective housing 120B of a third embodiment. The reflective housing 120B is differs from the reflective housing 120 in that a reflective surface 322 interconnecting an opening 326 and an fixing surface 324 is a smooth curved surface. The smooth curved surface of the fixing surface includes a concave surface and a convex surface smoothly adjoining the concave surface. The concave surface is adjacent to the opening 326, and the convex surface is adjacent to the fixing surface 324.

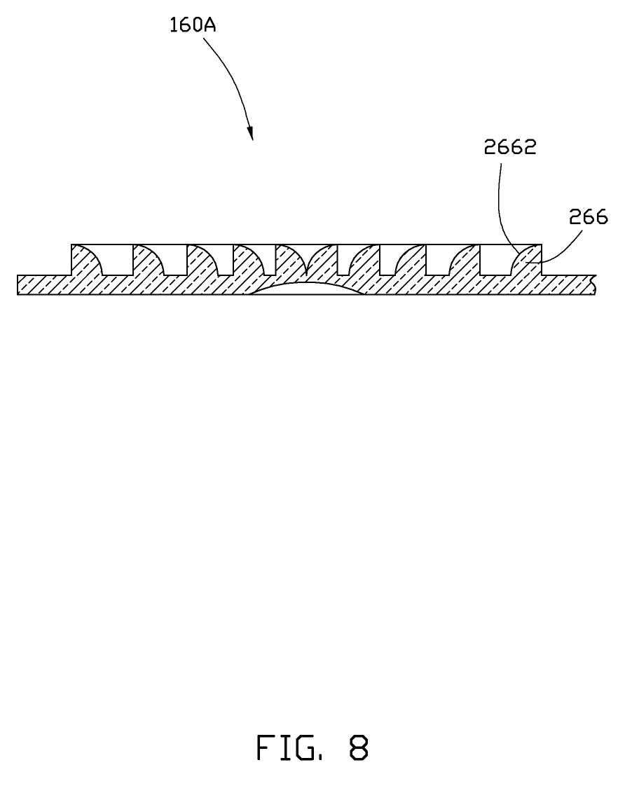

Referring to FIG. 8, this shows a light-pervious cover 160A of a fourth embodiment. The light-pervious cover 160A differs from the light-pervious cover 160 in that each of concentric ring-shaped prisms 266 has a cross section different from the ring-shaped prism 166. A contour of the cross section of the ring-shaped prism 266 has a similar shape to the ring-shaped prism 166, with a difference in that a convex arc 2662 replaces a bevel side of the triangular contour of the ring-shaped prism 1662 that is adjacent to the central axis O2.

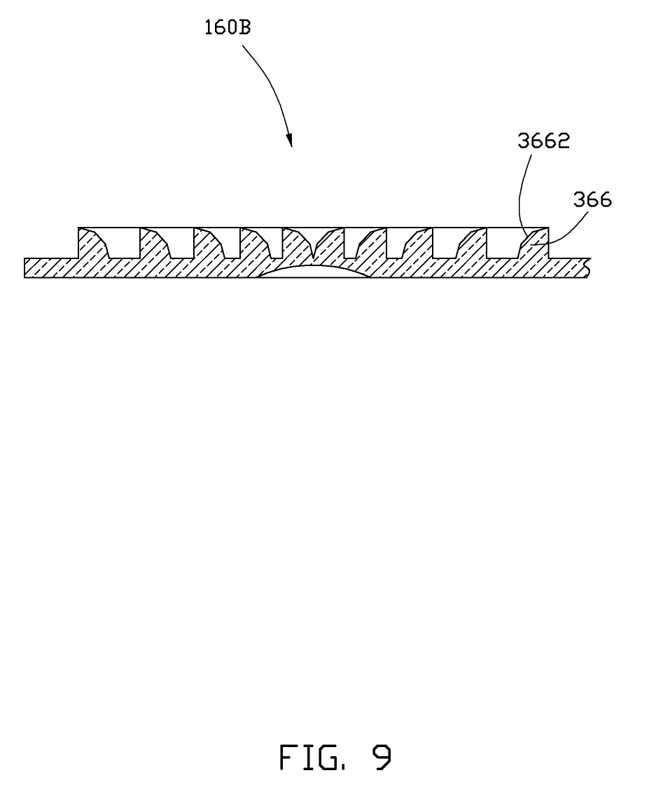

Referring to FIG. 9, this shows a light-pervious cover 160B of a fifth embodiment. The light-pervious cover 160B differs from the light-pervious cover 160 in that each of concentric ring-shaped prisms 366 has a cross section different from the ring-shaped prism 366. A contour of the cross section of the ring-shaped prism 366 has a similar shape to the ring-shaped prism 166, with a difference that a convex broken line 3662 replaces the bevel side of the triangular contour of the ring-shaped prism 1662 that is adjacent to the central axis O2. The broken line 3662 projects outward the ring-shaped prism 366. The broken line 3662 includes a plurality of line segments connected one after another in order, thereby forming a substantially curved line curved toward the central axis of the concentric ring-shaped prism 366. Preferably, the number of the line segments of the broken line 3662 is more than three.

The ring-shaped prism 266 of the fourth embodiment has a contour including a convex arc line, and ring-shaped prism 366 of the fifth embodiment has a contour of a convex broken line. These shapes cause tops of the ring-shaped prisms to become obtuse. It is clear then, that the obtuse top causes the ring-shaped prism to be stripped from a mold device more easily when the ring-shaped prism is made by a molding process. Also, the obtuse top can prevent from being damaged.

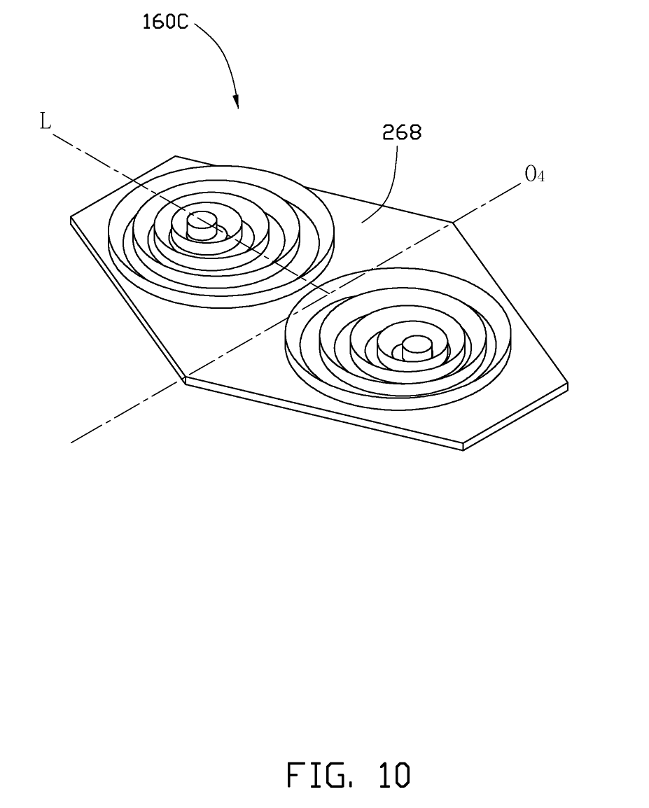

Referring to FIG. 10, this shows a light-pervious cover 160C of a sixth embodiment. The light-pervious cover 160C differs from the light-pervious 160 in that a ring-shaped prism group 268 of the light-pervious cover 160C is non-concentric. In this illustrated embodiment, ring-shaped prisms of the ring-shaped prism group 268 circle one after another in order. That is, in any two ring-shaped prisms of the ring-shaped group 268, the ring-shaped prism with smaller diameter is circled by the ring-shaped prism with larger diameter. In this exemplary embodiment, centers of the ring-shaped prisms of the ring-shaped prism group 268 are in a same straight line L, and the straight line L is perpendicular to the axial line O4 of the light-pervious base panel 162 that corresponds to the axial line O1 in FIG. 1.

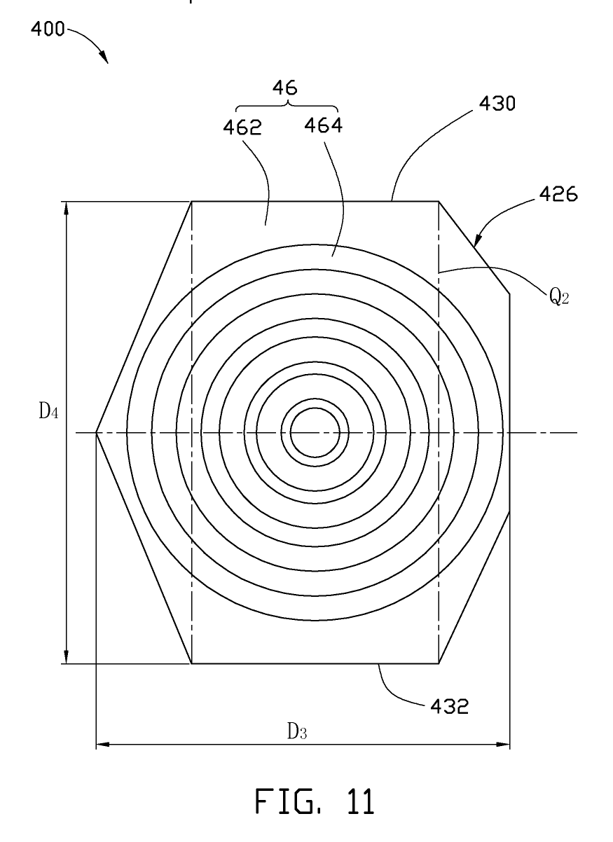

Referring to FIG. 11, this shows an LED illuminator 400 of a seventh embodiment. The LED illuminator 400 includes a reflective housing (not shown), an LED light source (not shown) and a light-pervious cover 460. The reflective housing of the LED illuminator 400 has an opening 426 with a shape different from the opening 126, and a fixing surface (not shown) with a shape different from the fixing surface 130. The opening 426 has a same shape as the fixing surface of the LED illuminator 400. Therefore, only the opening 426 is described in detail as follows. The opening 426 has a heptagonal shape having two parallel sides 430 and 432. Four endpoints of the two parallel sides 430 and 432 cooperatively form an imaginary quadrangle Q2. The remaining three endpoints of the opening 426 are located at an exterior of the imaginary quadrangle Q2, wherein two of them are adjacent one side of the quadrangle Q2 and the other one is adjacent to an opposite side of the quadrangle Q2, thereby forming two structures projected from the imaginary quadrangle Q1. Straight lines parallel with the parallel sides 430 and 432 are intersected by the sides of the opening 426 to form line segments. The longest one of the line segments has a distance D3. The distance D3 is smaller than a distance D4 between the two parallel sides 430. The light-pervious cover 460 includes a light-pervious plate 462 and a ring-shaped prism group 464 formed on the light-pervious plate 462. The light-pervious plate 462 has a same shape as the opening 426 and fixed to the wall of the reflective housing at the opening 426. The ring-shaped prism group 464 is identical with the ring-shaped prism group 166 of the first embodiment.

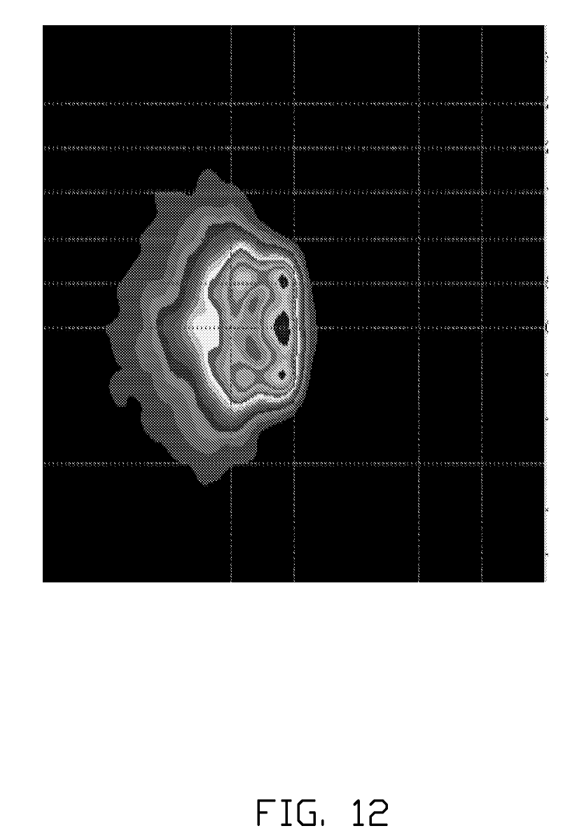

Referring to FIG. 12, this shows a light field of the LED illuminator 400 is shown. As described above, the distance D3 is smaller than the distance D4, therefore, the light field of the LED illuminator 400 has an approximate elongated shape. This light field is advantageous when the LED illuminator 400 is for a street lamp, because more light will be utilized to illuminate the street. Additionally, there are structures projected from the imaginary quadrangle Q2, therefore, more light will be reflected to the opening 426 than by using an illuminator with a quadrangle opening, thereby forming a larger light field. Further more, with diffusion of ring-shaped prism group 464, the brightness in the light field distributes uniformly.

It can be understood that the above-described embodiment are intended to illustrate rather than limit the disclosure. Variations may be made to the embodiments and methods without departing from the spirit of the disclosure. Accordingly, it is appropriate that the appended claims be construed broadly and in a manner consistent with the scope of the disclosure.

What is claimed is:

1. A reflective housing for a LED illuminator comprising:
a plurality of side walls cooperatively forming a hollow shell,
the hollow shell having a first opening and a second opening opposite to the first opening,
the hollow shell tapering from the first opening to the second opening, inner surfaces of the side walls being light reflective surfaces,
the first opening having a polygonal shape having more than four sides, the first opening comprising two parallel sides, four endpoints thereof cooperatively forming an imaginary quadrangle, remaining sides being located at an exterior of the imaginary quadrangle, a line segment obtained by intersecting any straight lines parallel to the parallel sides being shorter than a distance between the two parallel sides,
the second opening configured for accommodating an LED light source therein.

2. The reflective housing of claim 1, wherein each of the inner surfaces of the side walls is selected from the group consisting of a flat surface, a concave surface, and a smooth curved surface comprising a concave surface and a convex surface adjoining the concave surface.

3. The reflective housing of claim 1, further comprising a bottom wall at the second opening, the bottom wall being fixed to one distal end of each of the side walls at the second opening, the bottom wall configured for mounting the LED light source thereon.

4. An LED illuminator comprising:
a reflective housing of claim 1;
at least one LED light source positioned at the second opening; and
a light-pervious cover comprising:
a light-pervious plate fixed to the reflective housing at the first opening and covering the first opening;
a plurality of light diffusing micro-structures formed on the light-pervious plate, the light diffusing micro-structures being configured for diffusing light emitted from the at least one LED light source.

5. The LED illuminator of claim 4, wherein each of the inner surfaces of the side walls is selected from the group consisting of a flat surface, a concave surface, and a smooth curved surface comprising a concave surface and a convex surface smoothly adjoining the concave surface.

6. The LED illuminator of claim 4, further comprising a bottom wall at the second opening, the bottom wall being fixed to one distal end of each of the side walls at the second opening, the at least one LED light source fixed on an inner surface of the bottom wall.

7. The LED illuminator of claim 4, wherein the light diffusing micro-structures comprise a plurality of concentric ring-shaped prisms.

8. The LED illuminator of claim 7, wherein the ring-shaped prisms are concentric ring-shaped prisms, and the concentric ring-shaped prisms have a common central axis passing through the at least one LED light source.

9. The LED illuminator of claim 8, wherein each of the ring-shaped prisms has a triangular cross section, the triangular cross section of the ring-shaped prism having a base located on the light-pervious plate.

10. The LED illuminator of claim 9, wherein the triangular cross section of each of the ring-shaped prisms defines two base angles α and β, the base angle α adjacent to the central axis being smaller than the base angle β.

11. The LED illuminator of claim 8, wherein the cross section of each of the ring-shaped prisms has a contour comprising two line segments and an arc connected end to end, the arc curved toward the central axis of the concentric ring-shaped prisms.

12. The LED illuminator of claim 8, wherein the cross section of each of the ring-shaped prisms has a polygonal contour with more than five sides, one side of the polygon being on the light-pervious plate, another one of the sides facing away from the central axis of the concentric ring-shaped prisms, the remaining sides forming a substantially curved line curved toward the central axis of the concentric ring-shaped prism.

13. The LED illuminator of claim 8, wherein distances between two adjacent ring-shaped prisms gradually increase along a radial direction from a center to a periphery of the ring-shaped prisms.
